(19) United States
(12) Patent Application Publication
(10) Pub. No.: US 2025/0173790 A1
(43) Pub. Date: May 29, 2025

(54) SYSTEMS AND METHODS FOR GENERALIZING ASSET TOKENIZATION AND INTERACTING WITH AND CONTROLLING ON-CHAIN ASSETS USING DISTRIBUTED LEDGER TECHNOLOGY

(71) Applicant: JPMORGAN CHASE BANK, N.A., New York, NY (US)

(72) Inventors: Marlee BURR, Manhattan, NY (US); Chang Yang JIAO, New York, NY (US); Ganesh ANANTWAR, Mumbai (IN); Keerthi MOUDGAL, Brooklyn, NY (US); Tyrone LOBBAN, Loughton (GB); Manmeet AHLUWALIA, Tampa, FL (US); Nicolas ZHANG, Brooklyn, NY (US)

(21) Appl. No.: 18/410,732

(22) Filed: Jan. 11, 2024

(30) Foreign Application Priority Data
Nov. 29, 2023 (IN) 202311081022

(51) Int. Cl. G06Q 40/06

(52) U.S. Cl. CPC G06Q 40/06; G06Q 2220/10

(57) ABSTRACT

Systems and methods for generalizing asset tokenization and interacting with and controlling on-chain assets using distributed ledger technology are disclosed. In one embodiment, a method may include (1) receiving, at a balance manager computer program, an instruction from a participant to request a mint or burn of an asset token and a preference for balance manager assistance; (2) assisting, by the balance manager computer program, the participant with the request to mint or burn the asset token in accordance with the preference, resulting a transaction; and (3) sending, by the balance manager computer program, the transaction to an asset token router to call a mint or burn request on an asset token contract for the asset token. The asset token router calls the mint or burn request on the asset token contract.

### BACKGROUND OF THE INVENTION

### 1. Field of the Invention

Embodiments relate to systems and methods for generalizing asset tokenization and interacting with and controlling on-chain assets using distributed ledger technology.

### 2. Description of the Related Art

Real-word, or fungible, assets may be represented on distributed ledgers through the use of code or “smart contracts.” These assets may interact with applications that facilitate some behavior with that asset, such as sale of the asset, lend of the asset, coupon payment to that asset's owner, redemption of the asset, etc. Often there are multiple creators/developers of assets and applications; thus, in order for assets to work with the majority of the applications, and vice-versa, it is important that both assets and applications converge on and adhere to a standard on how they interact with each other.

### SUMMARY OF THE INVENTION

Systems and methods for generalizing asset tokenization and interacting with and controlling on-chain assets using distributed ledger technology are disclosed. In one embodiment, a method may include (1) receiving, at a balance manager computer program, an instruction from a participant to request a mint or burn of an asset token and a preference for balance manager assistance; (2) assisting, by the balance manager computer program, the participant with the request to mint or burn the asset token in accordance with the preference, resulting a transaction; and (3) sending, by the balance manager computer program, the transaction to an asset token router to call a mint or burn request on an asset token contract for the asset token. The asset token router calls the mint or burn request on the asset token contract.

In one embodiment, the preference may be based on a construction of a transaction payload for the transaction and/or encoding of the transaction payload for the transaction.

In one embodiment, the preference may be based on access to a key for the participant and signing the transaction.

In one embodiment, the preference may be based on validation of a signature on a transaction payload.

In one embodiment, the preference may be based on validation of a signature on a transaction payload.

In one embodiment, the method may also include receiving, by the balance manager computer program, an instruction to approve or reject the mint or burn request from a tokenization agent, and the asset token router calls a mint or burn function on the asset token contract.

In one embodiment, an amount in an account equal to a burn amount may be deducted and placed in a pending state in response to a successful burn.

According to another embodiment, a method may include: (1) receiving, by a token manager computer program, an instruction from a token administrator to activate or deactivate an asset token or an account for the asset token and a preference for token manager assistance; (2) assisting, by the token manager computer program, the token administrator with the instruction to activate or deactivate the asset token or the account for the asset in accordance with the preference resulting in a transaction; and (3) sending, by the token manager computer program, the transaction to an asset token router to call an activate or deactivate function on an asset token contract. The asset token router calls the activate or deactivate function on an asset token contract.

In one embodiment, the preference may be based on a construction of a transaction payload for the transaction and/or encoding of the transaction payload for the transaction.

In one embodiment, the preference may be based on access to a key for the token administrator and signing the transaction.

In one embodiment, the preference may be based on validation of a signature on a transaction payload.

In one embodiment, the preference may be based on validation of a signature on a transaction payload.

According to another embodiment, a method may include: (1) receiving, by a default manager computer program, an instruction from an operational manager to perform an operation with an asset token balance in an account and a preference for operational manager assistance; (2) assisting, by the default manager computer program, the operational manager with the request to perform the operation in accordance with the preference, resulting in a transaction; and (3) sending, by the default manager computer program, the transaction to an asset token router to call a function for the operation on an asset token contract. The asset token router calls the function on an asset token contract.

In one embodiment, the operation may be to lock or unlock a balance in an account.

In one embodiment, the operation may be to force transfer of a locked balance in an account.

In one embodiment, the operation may be to force burn a locked balance in an account.

In one embodiment, the preference may be based on a construction of a transaction payload for the transaction and/or encoding of the transaction payload for the transaction.

In one embodiment, the preference may be based on access to a key for the token administrator and signing the transaction.

In one embodiment, the preference may be based on validation of a signature on a transaction payload.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for interacting with and controlling on-chain assets using distributed ledger technology according to an embodiment;

FIG. 2 illustrates a method for asset token deployment according to an embodiment;

FIG. 3 illustrates a method for requesting mint or burn of an asset token according to an embodiment;

FIG. 4 illustrates a method for approving or rejecting an asset token mint or burn request according to an embodiment;

FIG. 5 illustrates a method for activating or deactivating an asset token or an account according to an embodiment;

FIG. 6 illustrates a method for locking an asset token balance at an account, unlocking a locked balance at an account, force burning a locked balance, or force transferring a locked balance according to an embodiment;

FIG. 7 depicts an exemplary computing system for implementing aspects of the present disclosure.

### DETAILED DESCRIPTION OF PREFERRED EMBODIMENTS

Embodiments relate to systems and methods for generalizing asset tokenization and interacting with and controlling on-chain assets using distributed ledger technology.

Embodiments may ensure that a token administrator has control over the assets when certain events take place, such as sanction of an asset or entity, or a default. Embodiments may also ensure that the token administrator has control over which on-chain applications and entities interact with asset tokens by allowing or disallowing an address on the asset tokens. Embodiments may also ensure that the operational administrator has control over the assets wen certain events take place, such as a default.

In embodiment, parties may interact with both the asset token via a tokenization service and with the smart contract design, which includes variables (e.g., token name, symbol, decimals, metadata, etc.) and the token functions. Parties may not be participants in the blockchain network, and may instead interact with the blockchain network via the tokenization service.

In addition, embodiments may track certain relationship information in order to allow for asset re-hypothecation.

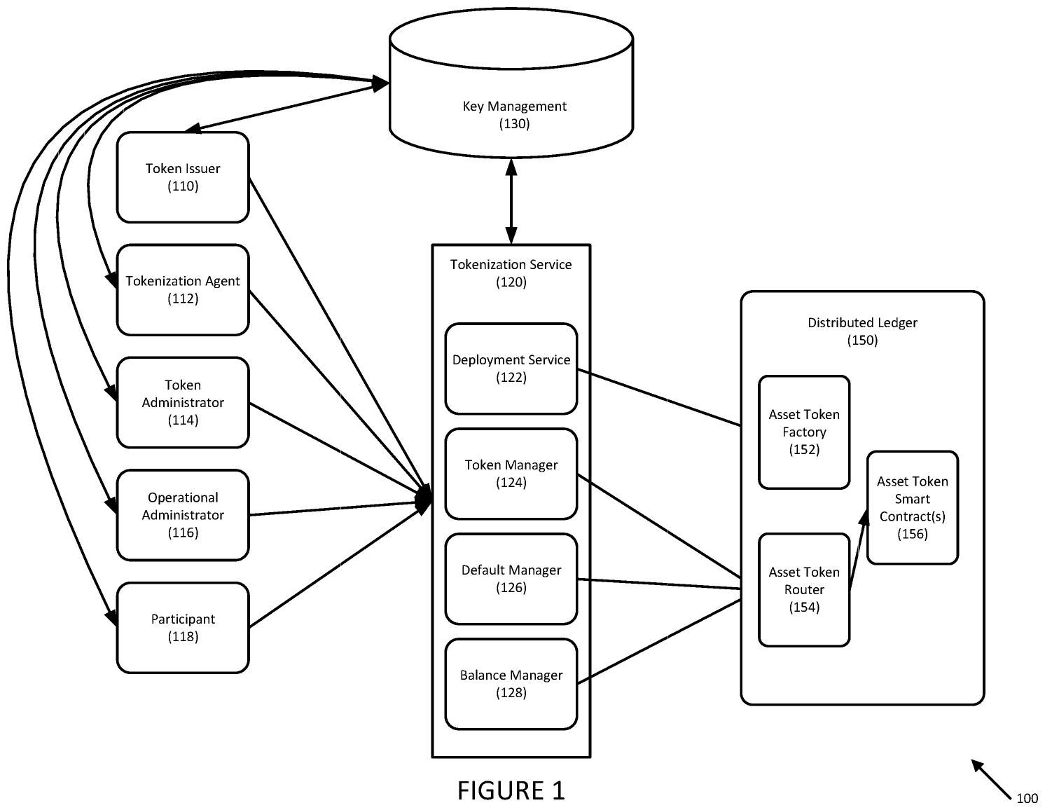

Referring to FIG. 1, a system for interacting with and controlling on-chain assets using distributed ledger technology is disclosed according to one embodiment. System 100 may include parties, such as token issuer 110, tokenization agent 112, token administrator 114, operational administrator 116, and participant 118. Other parties may be included as is necessary and/or desired.

Token issuer 110, which may be a party that deploys asset tokens, either by using deployment service 122, which may be a part of tokenization service 120, or by issuing asset tokens independently on distributed ledger 150. Token issuer 110 may be responsible for defining the asset token, which may be a set of data fields and functions that represent an asset on distributed ledger 150. Token issuer 110 may keep track of accounts that own balances of the asset token.

Tokenization agent 112 may be a trusted third party that is responsible for creating and destroying balances of asset tokens. Tokenization agent 112 may ensure that an asset token balance is only created or destroyed when certain predetermined conditions are met.

Token administrator 114 may be a party that is responsible for overseeing the asset token and performing certain control functions, such as activate or deactivate an asset token, activate or deactivate an account for an asset token, etc.

Operational administrator 116 may be a party that is responsible for overseeing the asset token as it relates to default events, for example, and may perform certain control functions on the asset token when predetermined conditions are met. Token administrator 114 may set an operation administrator 116 for an asset token and may revoke operational administrator's 116 role. Both token administrator 114 and operational administrator 116 may be related to a specific asset token.

Operational administrator 116 may be a party that has the ability to lock or unlock a balance of the asset token owned by an account, to force burn a locked balance, to force transfer a locked balance to another account, etc. When a locked balance is force transferred to another account, it remains in a locked state at the new account.

Account participant 118 may be party, such as an account, that can own and/or interact with an asset token.

Tokenization service 120 may include a set of subservices that interact with the asset token on behalf of other parties on the network. Parties may interact with tokenization service 120 via Applicant Programming Interface (“API”) and/or User Interface (“UI”). Subservices of tokenization service 120 may access the parties' private keys to interact with the asset token on their behalf. Tokenization service 120 subservices may include computer programs such as deployment service 122, token manager 124, default manager 126, and balance manager 128.

Certain subservices of tokenization service 120 (e.g., token manager 124, default manager 126, and balance manager 128) may maintain and enforce access controls such that only an address associated with or for a necessary role can interact with that sub-service. For example, for balancer manager 128, the address must be for tokenization agent 112 or participant 118. For token manager 124, the address must be for token administrator 114. For default manager 126, the address must be for operational administrator 116.

It should be noted that, in embodiments, deployment service 122 may not require the address to be associated with a role.

The assistance to the party provided by the subservices of tokenization service 120 may be based on the party's preferences. A subservice of tokenization service 120 may assist the party in any combination of the following: constructing the transaction payload, encoding the transaction payload, accessing the party's key and signing the encoded transaction. The party may choose to perform any or all the above-mentioned actions independently of the subservice. At a minimum, the subservice will submit the party's signed transaction to distributed ledger 150, such as a blockchain.

Deployment service 122 may enable token issuer 110 to deploy a new asset token without directly interacting with distributed ledger 150. Token issuer 110 may interact with distributed ledger 150 if it submits the transaction directly.

Deployment service 122 may also enable token issuer 110 to deploy asset tokens without constructing the contract transaction payload by passing the type of asset token (such as an onboarded asset token that deployment service 122 has awareness of) and required parameters for the asset token contract (e.g., name, symbol, decimals, metadata, tokenization agent address). Deployment service 122 may interact with, for example, an asset factory contract 152 (e.g., a smart contract that deploys contracts).

Asset token factory 152 may facilitate the creation of asset token contracts following one token design (ODA-FACT or others). Deployment service 122 may call the asset token factory, and may pass it the required parameters to define the asset token. Once certain conditions are met (e.g., the correct function called, sufficient parameters passed, etc.), asset token factory 152 may then deploy the new asset token contract to distributed ledger 150.

Token manager 124 may allow token administrator 114 to interact with certain asset token functions without directly interacting with the distributed ledger 150. In one embodiment, token manager 124 may allow token administrator 114 to deactivate an account for a given token, activate a deactivated account for a given token, and deactivate an asset token, and activate an asset token.

Token manager 124 may allow token administrator 114 to set and delete the operational administrator for a given token. Token manager 124 may interact with a token router contract to batch call multiple asset tokens (i.e., may interact with multiple asset tokens at once).

Asset token router 154 may be a type of token router contract. Token manager 124 may send asset token router 154 the address of the target contract(s), the function ID (i.e., the function to be called on that contract), and encoded parameters of call data. Asset token router 154 may allow the message sender to send transactions of the same type to asset token smart contracts 156 at one time in a “batch.” There may be one asset token router 154 for all of the asset token functions, or there may be multiple asset token routers 154, each supporting different types of functions.

Default manager 126 may allow operational administrator 116 to interact with certain asset token functions without directly interacting with the distributed ledger. For example, default manager 126 may allow operational administrator 116 to lock an asset token balance, unlock an asset token balance, force burn a locked token balance, and force transfer a locked token balance. Default manager 126 may also interact with asset token router 154 to batch call multiple asset tokens.

Balance manager 128 may allow participant 118 and tokenization agent 112 to interact with certain asset token functions without directly interacting with the distributed ledger. For example, balance manager 128 may allow participant 118 to submit a mint request and a burn request. For example, balance manager 128 may also allow tokenization agent 112 to interact with certain asset token functions, such as mint approve, mint reject, burn approve, and burn reject.

Key management 130 may maintain keys for several entities, including token issuer 110, tokenization agent 112, token administrator 114, operational administrator 116, and participant 118.

Embodiments may involve fungible and non-fungible asset tokens, which may be sets of data fields and functions that represent fungible and non-fungible assets on a distributed ledger. Asset tokens keep track of account(s) that own balances of the asset tokens and enable interaction with those balances.

In one embodiment, participant 118 may call additional functions, such as Request Mint Approval or Request Burn Approval, to allow a second participant (not shown) to call the mint request or mint burn, respectively, on participant 118's behalf.

Similarly, participant 118 may be a delegate for second participant (not shown), and may call functions, such as Request Mint From or Request Burn From, to request mint of some amount to the requester's address, or to request burn of some amount to the requester's address, respectively.

Participant 118 may interact with these functions through balance manager 128 in the same manner as it interacts with balance manager 128 to request mint or burn.

In one embodiment, the mint/burn approve/reject functions called by tokenization agent 112 may follow the same flow as when participant 118 requests mint/burn for its own address.

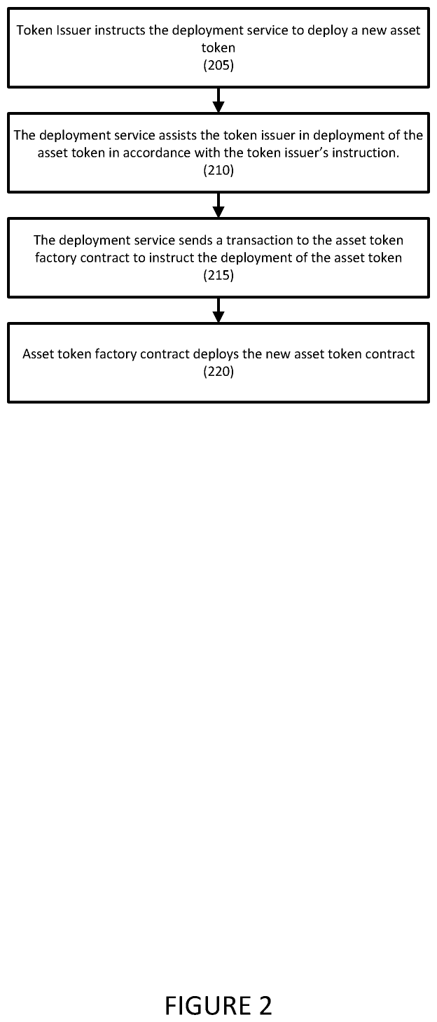

Referring to FIG. 2, a method for asset token deployment is disclosed according to one embodiment.

In step 205, token issuer may instruct the deployment service to deploy an asset token. The instruction may include preferences on how the deployment service will assist in the deployment of a new asset token contract and required inputs from the token issuer.

In step 210, the deployment service may assist the token issuer in deployment of the asset token contract. The deployment service may assist the token issuer in deploying an asset token contract in different ways, depending on the token issuer's preference. For example, the deployment service may construct the transaction payload, encode the transaction payload, access the token issuer's keys, and sign on their behalf and submit the transaction to the distributed ledger. As another example, the deployment service may construct the transaction payload, encode the transaction payload, send encoded transaction payload to the token issuer for signing, receive the signed transaction payload, validate the signature, and submit the transaction to the distributed ledger. As another example, the deployment service may construct the transaction payload, send the transaction payload to the token issuer for encoding and signing, receive the signed transaction payload, validate the signature, and submit the transaction to the distributed ledger. As yet another example, the deployment service may receive a signed, encoded transaction payload, validate the signature, and submit the transaction to the distributed ledger.

In step 215, the deployment service may send a transaction to the asset token factory contract to instruct the deployment of the asset token contract. In one embodiment, the keys may be used by the token issuer or the deployment service to sign the transaction that is sent to the factory contract required to deploy the new asset token contract.

In step 220, the asset token factory contract may deploy the new asset token contract.

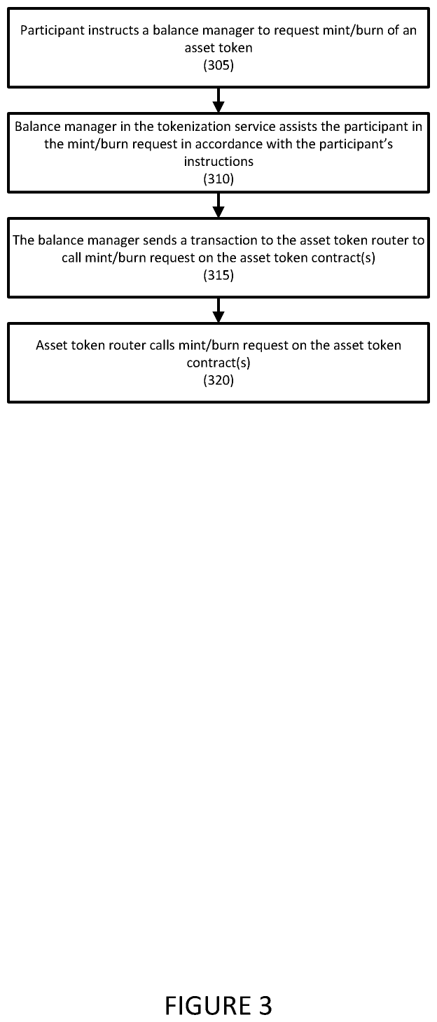

Referring to FIG. 3, a method for requesting mint and burn of an asset token is disclosed according to one embodiment. In this embodiment, the asset token contract has been deployed.

In step 305, a participant, such as a holder of an asset, may instruct the balance manager to request mint/burn of a balance of an asset token. The instruction may include preferences on how the balance manager will assist in the mint/burn request and required inputs from the participant.

In step 310, a balance manager in the tokenization service may assist the participant in mint/burn request in accordance with the participant's instruction. The balance manager may assist a participant or tokenization agent in a few different ways, depending on the participant's preferences. For example, the balance manager may construct the transaction payload, encode the transaction payload, access the participant's keys and sign on their behalf, and submit the transaction to the distributed ledger. As another example, the balance manager may construct the transaction payload, encode the transaction payload, send encoded transaction payload to the participant for signing, receive the signed transaction payload, validate the signature, and submit the transaction to the distributed ledger. As another example, the balance member may construct the transaction payload, send transaction payload to the participant for encoding and signing, receive the signed transaction payload, validate the signature, and submit the transaction to the distributed ledger. As yet another example, the balance manager may receive a signed, encoded transaction payload, validate the signature, and submit the transaction to the distributed ledger.

In step 315, the balance manager may send a transaction to the asset token router to call mint/burn request on the asset token contract(s).

In step 320, the asset token router may call a mint/burn request on the asset token contract(s).

In one embodiment, the tokenization agent may recognize that a mint or burn has been called, and may “match” the request by calling an approve or reject function. When a request function is called on an asset token by a participant, an identifier may be created and the response (reject/approve function) called by the tokenization agent must include the same identifier as a parameter to the function. A request mint/burn can remain “unmatched” indefinitely.

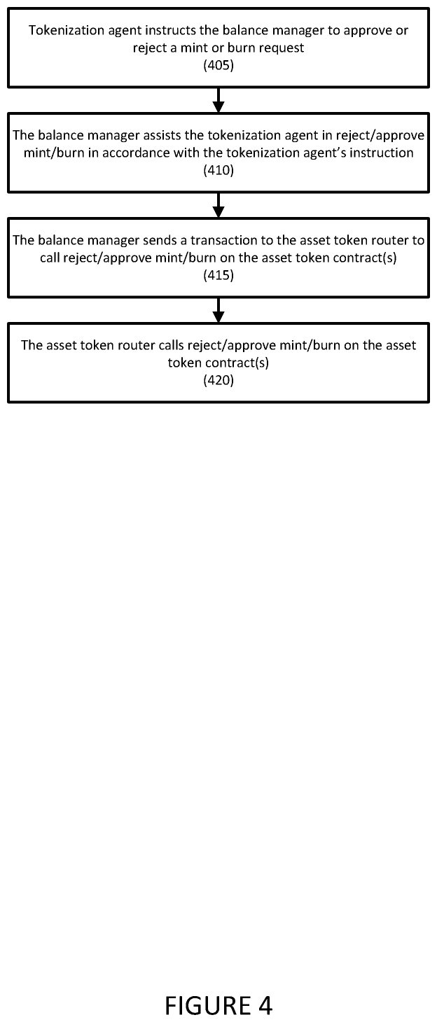

The process may continue, for example, with the method of FIG. 4.

Referring to FIG. 4, a method for approving and rejecting an asset token mint or burn is disclosed according to an embodiment.

In step 405, a tokenization agent may instruct the balance manager to approve or reject a mint or burn request. The instruction will include preferences on how the balance manager will assist in the approve/reject mint/burn and required inputs from the tokenization agent.

In step 410, a balance manager in the tokenization service may assist the tokenization agent in rejecting or approving the mint or burn request in accordance with the tokenization agent's instruction. The balance manager may assist the tokenization agent in a few different ways, depending on the tokenization agent's preferences. For example, the balance manager may construct the transaction payload, encode the transaction payload, access the tokenization agent's keys and sign on their behalf, and submit the transaction to the distributed ledger. As another example, the balance manager may construct the transaction payload, encode the transaction payload, send encoded transaction payload to the tokenization agent for signing, receive the signed transaction payload, validate the signature, and submit the transaction to the distributed ledger. As another example, the balance member may construct the transaction payload, send transaction payload to the tokenization agent for encoding and signing, receive the signed transaction payload, validate the signature, and submit the transaction to the distributed ledger. As yet another example, the balance manager may receive a signed, encoded transaction payload, validate the signature, and submit the transaction to the distributed ledger.

In step 415, the balance manager may send a transaction to the asset token router to call a reject or approve mint or burn function on the asset token contract(s).

In step 420, the asset token router may call a reject or approve mint or burn function on the asset token contract(s).

In embodiments, the account requesting burn must have a balance greater than or equal to the burn request amount. When the burn request function is successfully called, the amount is deducted from the account balance and is placed in a pending state, the balance in a pending state cannot move around. When the tokenization agent approves the burn request that pending balance decreases in its entirety, if the burn request is rejected, the pending amount decreases in its entirety and the account's balance increases by the same amount.

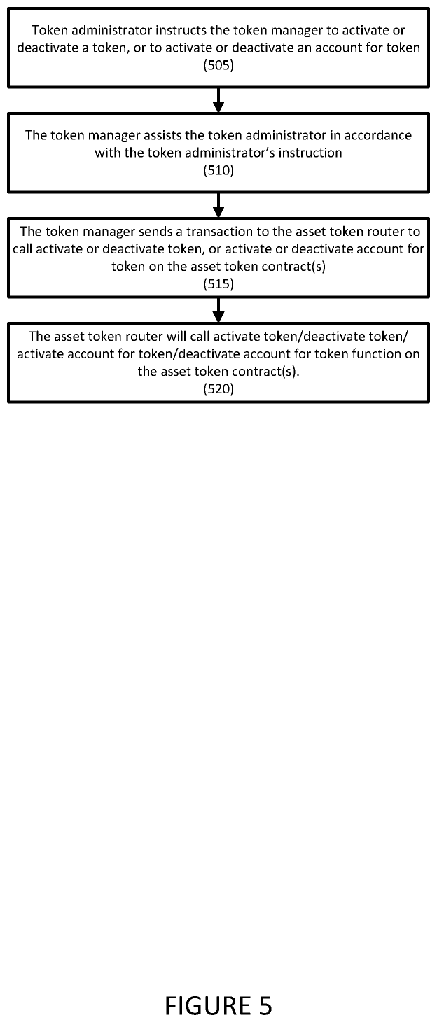

Referring to FIG. 5, a method for activating or deactivating an asset token or an account is disclosed according to an embodiment.

In step 505, the token administrator may instruct the token manager to activate, or deactivate an asset token, or to activate or deactivate an account for token. In one embodiment, the token administrator may pass the asset token address, the account (if required), and the function (i.e., activate or deactivate) that would like to call.

In step 510, the token manager may assist the token administrator in different ways, depending on the token administrator's instruction. For example, the token manager may construct the transaction payload, encode the transaction payload, access the token administrator's keys and sign on its behalf, and submit the transaction to the distributed ledger. As another example, the token manager may construct the transaction payload, encode the transaction payload, send encoded transaction payload to the token administrator for signing, receive the signed transaction payload, validate the signature, and submit the transaction to the distributed ledger. As another example, the token manager may construct the transaction payload, send transaction payload to the token administrator for encoding and signing, receive the signed transaction payload, validate the signature, and submit the transaction to the distributed ledger. As yet another example, the token manager may receive a signed, encoded transaction payload, validate the signature, and submit the transaction to the distributed ledger.

In step 515, the token manager may send a transaction to the asset token router to call an activate or deactivate token function, or activate or deactivate account for token function on the asset token contract(s).

In step 520, the asset token router may call an activate or deactivate token function, or activate or deactivate account for token function on the asset token contract(s).

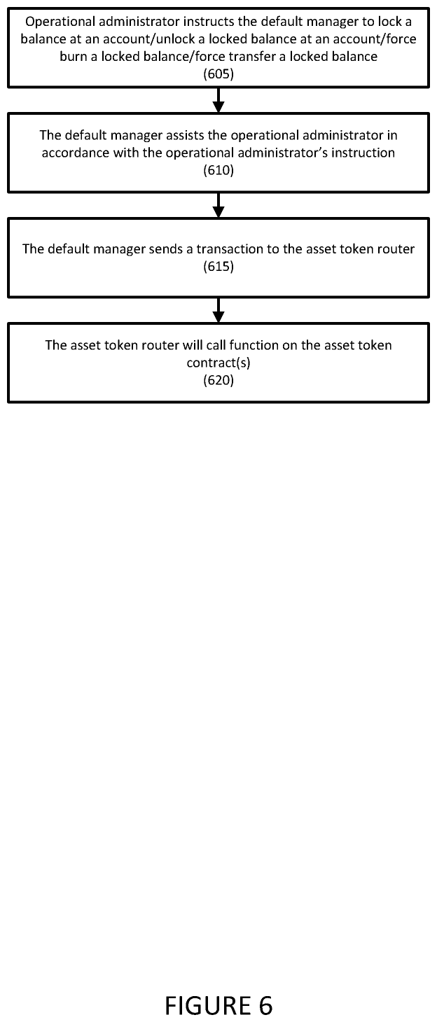

Referring to FIG. 6, a method for locking a balance at account, unlocking a locked balance at an account, force burning a locked balance, or force transferring a locked balance is disclosed according to an embodiment.

In step 605, an operational administrator may instruct the default manager to lock a balance at an account, to unlock a locked balance at an account, to force burn a locked balance, or to force transfer a locked balance. The instruction may identify the accounts.

In step 610, the default manager may assist the operational administrator in different ways, depending on the operational administrator's instruction. For example, the default manager may construct the transaction payload, encode the transaction payload, access the operational administrator's keys and sign on its behalf, and submit the transaction to the distributed ledger. As another example, the default manager may construct the transaction payload, encode the transaction payload, send encoded transaction payload to the operational administrator for signing, receive the signed transaction payload, validate the signature, and submit the transaction to the distributed ledger. As another example, the default manager may construct the transaction payload, send transaction payload to the operational administrator for encoding and signing, receive the signed transaction payload, validate the signature, and submit the transaction to the distributed ledger. As yet another example, the default manager may receive a signed, encoded transaction payload, validate the signature, and submit the transaction to the distributed ledger.

In step 615, the default manager may send a transaction to the asset token router to lock a balance at an account, to unlock a locked balance at an account, to force burn a locked balance, or to force transfer a locked balance.

In step 620, the asset token router may call a lock a balance at an account function, an unlock a locked balance function, a force burn a locked balance function, or a force transfer a locked balance function on the asset token contract(s).

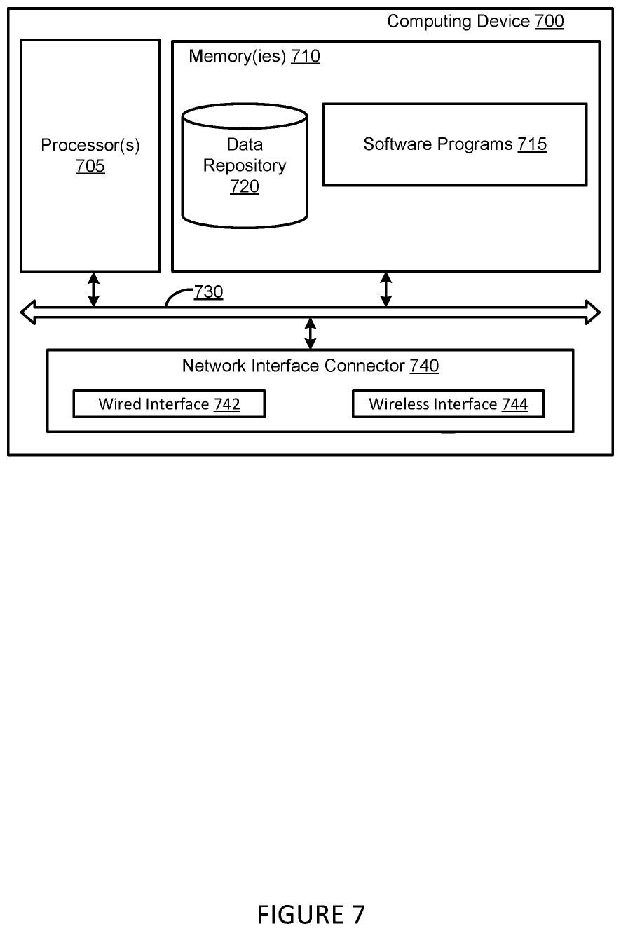

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a balance manager computer program, an instruction from a participant to request a mint or burn of an asset token and a preference for balance manager assistance;
assisting, by the balance manager computer program, the participant with the request to mint or burn the asset token in accordance with the preference, resulting a transaction; and
sending, by the balance manager computer program, the transaction to an asset token router to call a mint or burn request on an asset token contract for the asset token;
wherein the asset token router calls the mint or burn request on the asset token contract.

2. The method of claim 1, wherein the preference is based on a construction of a transaction payload for the transaction and/or encoding of the transaction payload for the transaction.

3. The method of claim 1, wherein the preference is based on access to a key for the participant and signing the transaction.

4. The method of claim 1, wherein the preference is based on validation of a signature on a transaction payload.

5. The method of claim 1, wherein the preference is based on validation of a signature on a transaction payload.

6. The method of claim 1, further comprising:
receiving, by the balance manager computer program, an instruction to approve or reject the mint or burn request from a tokenization agent;
wherein the asset token router calls a mint or burn function on the asset token contract.

7. The method of claim 1, wherein an amount in an account equal to a burn amount is deducted and placed in a pending state in response to a successful burn.

8. A method, comprising:
receiving, by a token manager computer program, an instruction from a token administrator to activate or deactivate an asset token or an account for the asset token and a preference for token manager assistance;
assisting, by the token manager computer program, the token administrator with the instruction to activate or deactivate the asset token or the account for the asset in accordance with the preference resulting in a transaction; and
sending, by the token manager computer program, the transaction to an asset token router to call an activate or deactivate function on an asset token contract;
wherein the asset token router calls the activate or deactivate function on an asset token contract.

9. The method of claim 8, wherein the preference is based on a construction of a transaction payload for the transaction and/or encoding of the transaction payload for the transaction.

10. The method of claim 8, wherein the preference is based on access to a key for the token administrator and signing the transaction.

11. The method of claim 8, wherein the preference is based on validation of a signature on a transaction payload.

12. The method of claim 8, wherein the preference is based on validation of a signature on a transaction payload.

13. A method, comprising:
receiving, by a default manager computer program, an instruction from an operational manager to perform an operation with an asset token balance in an account and a preference for operational manager assistance;
assisting, by the default manager computer program, the operational manager with the request to perform the operation in accordance with the preference, resulting in a transaction; and
sending, by the default manager computer program, the transaction to an asset token router to call a function for the operation on an asset token contract;
wherein the asset token router calls the function on an asset token contract.

14. The method of claim 13, wherein the operation is to lock an account.

15. The method of claim 13, wherein the operation is to lock or unlock a balance in an account.

16. The method of claim 13, wherein the operation is to force transfer of a locked balance in an account.

17. The method of claim 13, wherein the operation is to force burn a locked balance in an account.

18. The method of claim 13, wherein the preference is based on a construction of a transaction payload for the transaction and/or encoding of the transaction payload for the transaction.

19. The method of claim 13, wherein the preference is based on access to a key for the token administrator and signing the transaction.

20. The method of claim 13, wherein the preference is based on validation of a signature on a transaction payload.
